(19) United States
(12) Patent Application Publication
(10) Pub. No.: US 2023/0236083 A1
(43) Pub. Date: Jul. 27, 2023

(54) APPARATUS AND METHODS FOR INSPECTING OBJECTS AND STRUCTURES WITH LARGE SURFACES

(71) Applicant: Cybernet Systems Corp., Ann Arbor, MI (US)

(72) Inventors: Kevin Tang, Ann Arbor, MI (US); Charles Jacobus, Charlevoix, MI (US); Douglas Haanpaa, Ann Arbor, MI (US); Charles Cohen, Ann Arbor, MI (US)

(73) Assignee: Cybernet Systems Corp., Ann Arbor, MI (US)

(21) Appl. No.: 17/228,156

(22) Filed: Apr. 12, 2021

(51) Int. Cl. G01M 5/00; G06T 7/70; G06T 7/00; G06K 7/14; G06K 7/10

(52) U.S. Cl. CPC G01M 5/0091; G01M 5/0075; G01M 5/0033; G06T 7/70; G06T 7/0002; G06K 7/1417; G06K 7/10722; G06T 2200/24; G06T 2207/30204; G06T 2207/30108

(57) ABSTRACT

Continuous, multiple-point surveying or measurement is performed on large areas or objects. The results may be coordinated or combined with 3D localization systems or methods employing GPS, manual theodolites, range finders, laser radars or pseudolites. One disclosed example describes the use of the invention as applied to the problem of routine and repeated inspection of large aircraft, though the system and method are equally applicable to other objects with large surfaces including ships, bridges and large storage structures like tanks, buildings, and roadways.

### Field of the Invention

This invention relates generally to inspection and measurement and, in particular, to apparatus and methods for inspecting and measuring large structures, objects and areas.

### BACKGROUND OF THE INVENTION

Many large objects require routine inspection. Some examples include ships, aircraft, bridges, and large storage structures like tanks, buildings, and roadways. If these objects are outside (i.e., exposed to GPS signals) and the locations of the points of inspection known to about 2-5 cm are acceptable, precision GPS attached to inspection sensors for location tagging of inspection data is acceptable. However, if more accurate localization of the inspection is required, or if the object being inspected does not have GPS visibility or line of sight (to at least 5 satellites due to being indoors or amongst objects that obscure GPS line-of-sight to sufficient satellites), an alternative localization method is needed.

For less precise measurement, GPS substitutes like pseudolites can be used, however, accuracy achievable is comparable to GPS and these devices are also hard to employ and are costly. Such a system is described by U.S. Pat. No. 6,882,315.¹ ¹ Richley et al., Object Location System and Method, U.S. Pat. No. 6,882,315, Apr. 19, 2005.

Optical measurement approaches have been employed at least since the advent of the telescope² and its use for surveying.³ Gelbart, et. al. in U.S. Pat. No. 5,305,091⁴ describes an optical coordinate measurement approach that consists of multiple optical transceivers (transmitter-receivers) mounted onto a stable reference frame such as the walls of a room. The object to be measured is touched with a hand-held measuring probe. To measure, the probe triggers the transceivers to read the distance to two retroreflectors mounted on the probe. The location of the probe tip relative to the reference frame is computed from at least six transceiver readings (three for each retroreflector). ² Invented and patented by Dutch eyeglass maker Hans Lippershey in 1608. Also Galileo in 1609.³ Joshua Habermel made the first theodolite with a compass in 1576. Johnathon Sission incorporated the telescope into it in 1725. As a practice, surveying in some form dates back to at least the Egyptians in 1400 B.C.⁴ Gelbart, et al. Optical coordinate measuring system for large objects. U.S. Pat. No. 5,305,091. 19 Apr. 1994.

More recently, Borghese, et al., disclose Autoscan, a two camera 3D imaging system for capture of large area objects.⁵ Borghese's approach essentially employs stereo computer vision like that described in Ohta, et al.⁶ and Baker, et al.' Neitzel, et al., discloses a system that uses a UAV to move a camera around a large object the capture 3D mapping of the object.' Neitzel's system employs 3D reconstruction from multiple views of an object. This technology dates back to Hildreth,⁹ and later Mathies, Kanade, et. al.¹⁰ ⁵ Borghese, Nunzio Alberto, et al. “Autoscan: A flexible and portable 3D scanner.” IEEE Computer Graphics and Applications 18.3 (1998): 38-41.⁶ Ohta, Yuichi, and Takeo Kanade. “Stereo by intra-and inter-scanline search using dynamic programming.” IEEE Transactions on pattern analysis and machine intelligence 2 (1985): 139-154.⁷ Bolles, Robert C., H. Harlyn Baker, and David H. Marimont. “Epipolar-plane image analysis: An approach to determining structure from motion.” International journal of computer vision 1.1 (1987): 7-55. Also a citation that references work as early as 1982.⁸ Neitzel, Frank, and J. Klonowski. “Mobile 3D mapping with a low-cost UAV system.” Int. Arch. Photogramm. Remote Sens. Spat. Inf. Sci 38 (2011): 1-6.⁹ Hildreth, Ellen C. “Computations underlying the measurement of visual motion.” Artificial Intelligence 23.3 (1984): 309-354.¹⁰ Matthies, Larry, Takeo Kanade, and Richard Szeliski. “Kalman filter-based algorithms for estimating depth from image sequences.” International Journal of Computer Vision 3.3 (1989): 209-238.

Guidi, et al. discloses the use of 3D mapping to large area cultural (archeological) sites. His approach employs 3D time-of-flight laser radar units often used for aerial surveys. This technology was invented in the early 1960s, disclosed in U.S. Pat. No. 4,935,616,¹¹ pioneered at the Environmental Research Institute of Michigan (formerly University of Michigan Willow Run Laboratories), in 1980s as described in by McMannamon, et al.,¹² and used in mapping as described by Wesolowiz, et al.¹³ Localization on aircraft is described by Hadley, et al. in U.S. Pat. No. 7,873,494.¹⁴ His method does not directly measure location of arbitrary points on the aircraft, but rather identifies where a point is relative to other known locations on the aircraft (features readily identifiable in an image of the aircraft and designated as reference points with known locations relative to the three dimensional coordinate system of the aircraft). This approach assumes a geometric or CAD representation of the aircraft that defines its coordinate system, and reference points identified in that CAD database. ¹¹ Scott, et al., Range Imaging Laser Radar, U.S. Pat. No. 4,935,616, Jun. 19, 1990.¹² McManamon, Paul F., Gary Kamerman, and Milton Huffaker. “A history of laser radar in the United States.” Laser Radar Technology and Applications XV. Vol. 7684. International Society for Optics and Photonics, 2010.¹³ Wesolowicz, Karl G., and Robert E. Sampson. “Laser Radar Range Imaging Sensor for Commercial Applications.” SPIE. Vol. 783. 1987.¹⁴ Hadley, et al., Method and Apparatus for an Aircraft Location Position System, U.S. Pat. No. 7,873,494, Jan. 18, 2011.

### SUMMARY OF THE INVENTION

This invention enables continuous, multiple-point surveying and measurements of large areas and objects. The results may be coordinated or combined with 3D localization systems or methods employing GPS, manual theodolites, range finders, laser radars or pseudolites. The invention is ideally suited to the routine and repeated inspection of aircraft and other objects with large surfaces including ships, bridges, tanks, buildings, and roadways.

In accordance with a method of inspecting such surfaces, a marker is placed on a surface providing a unique computer-readable code. A camera gathers an image of the surface containing the marker. A programmed computer processes the image to develop a coordinate system defining the surface, with the location of the marker being defined as a point with particular coordinates with respect to the surface. This facilitates tracking or determining characteristics of the surface relative to the location of the marker.

The markers may be positioned at different locations on the surface, each marker having a different unique computer-readable code, and wherein coordinate system may define a full six-degree-of-freedom coordinate space. The computer-readable code may be a barcode or other passive code. Alternatively, the computer-readable code may be an encoded, light-emitting code or other active code. The step of tracking or determining characteristics of the surface relative to the location of the marker may include mapping the surface to create a computer-aided design (CAD) representation.

The method may further include the steps of coupling the marker to a sensor operative to collect sensor data at or in the vicinity of the marker, and merging the coordinates of the marker and the sensor data. For example, the sensor data may be imaging data; and the step of tracking or determining characteristics of the surface relative to the location of the marker may include generating a multi-staged or dimensional map of the surface.

The sensor data may be derived from a non-destructive inspection sensor, and the step of tracking or determining characteristics of the surface relative to the location of the marker may include the step of monitoring flaws or defects in the surface. The flaws or defects in the surface may be monitored over time.

The method may include the step of mounting the marker on a fixture, thereby enabling the computer-readable code to be imaged from multiple directions, lines of sight, or preferred viewing angles. The method may also further include the step of patching leapfrogged inspection areas to enable a contiguous inspection map.

A system for inspecting a surface in accordance with the invention may include a marker supported on the surface providing a unique computer-readable code; a camera operative to gather an image of the surface containing the marker; and a programmed computer operative to receive the image from the camera and develop a coordinate system defining the surface, with the location of the marker being defined as a point with particular coordinates on the surface. A human interface coupled to the programmed computer enables a user to track or determine characteristics of the surface relative to the location of the marker.

### BRIEF DESCRIPTION OF THE DRAWINGS

FIG. 1 is a diagram that illustrates the use of a single unique marker on a surface to be measured or inspected;

FIG. 2 shows the use of three unique markers on a surface;

FIG. 3 shows the use of four unique markers on a surface;

FIG. 4A illustrates the use of multiple tag marker coupled to an inspection sensor through a mount enable the codes to be seen from many different viewing angles;

FIG. 4B depicts alternative single-tag markers visible from about a 90-degree solid angle;

FIG. 5 illustrates alternative unique barcode tags applicable to the invention;

FIG. 6 is a block diagram that describes a software architecture applicable to the invention;

FIG. 7 illustrates an active marker (body) tracking device;

FIG. 8 shows object shape digitization made possible by the invention;

FIG. 9A is an image of an inspection area;

FIG. 9B illustrates the implementation of a manual grid overlay;

FIG. 9C shows the recording of readings on the grid; and

FIG. 9D shows the inspection results being exported.

### DETAILED DESCRIPTION OF THE INVENTION

This invention provides a system and related methods for performing continuous, multiple point surveying or measurement of large areas or objects. The measurement results may be coordinated or combined with other 3D localization systems employing GPS, manual theodolites, range finders, laser radars, pseudolites, and so forth. Disclosed examples deploy small passive unique targets that are attached to inspection sensors, and the targets are tracked accurately by one of more focal plane camera units set back at an offset from the area to be inspected.

The invention is not limited in terms of application area, and is particularly well suited to large areas, objects, structures and surfaces requiring routine inspection. Some examples include ships, aircraft, bridges, and large storage structures like tanks, buildings, and roadways. To find defects target areas must be systematically scanned, making sure no critical area has been overlooked. Accurate location of each sensor scan is necessary to ensure this (and also enables location-based depictions of inspection data). To track defects over time is necessary to accurately know sensor location so that the same defect can be revisited over time to allow tracking of progression.

Alternative uses of the disclosed location tag approach include:
Mapping of a large object—a number of location points form a 3-dimensional point cloud that can provide input to software that creates CAD representations of an as-built structure.
Multi-staged or dimensional mapping—for this, a sensor, perhaps a 3D imaging system or sensor, inspects a patch of the large object collecting a high-resolution point cloud over a small area. The 3D sensor itself is localized using the disclosed tracking system. Thus, each small point cloud is readily translated and rotated accurately into a large object coordinate system providing a means to collect very high-resolution aggregated point clouds of a large object to map it to fine detail and generate fine resolution CAD representations of its surfaces and features.

As one non-limiting example, tags and tracking of them have been employed for large area inspection of aircraft. To take measurements relative to the aircraft coordinate system, we typically place a version of the small passive targets at the center of the aircraft fuselage, and then offset individual tag measures from this aircraft central point, thus eliminating the need for aircraft geometry or CAD data (although the measurements can be registered to, or overlaid on, aircraft CAD information if it is available).

This disclosed application is driven by the need to inspect surfaces, including composite surfaces, and features to detect corrosion and delaminations that may weaken aircraft structures, but are often completely invisible to external visual inspection. Because the delaminations are often progressive, and size of the defective area is important. Target areas have to be found and tracked over time as part of the aircraft preventative maintenance process. This is also true for the detection of cracks and progression of cracks over time.

The invention is not limited in terms of the sensor technology used, and may include any NDI (nondestructive inspection/evaluation) method(s), including ultrasonics, eddy-current measurement, x-radiography, laser interferometry, holographic interferometry and electronic speckle shearography (ES). In the preferred embodiments, the inspection is carried out with the NDI sensors described in U.S. Pat. Nos. 6,043,870¹⁵ and 6,040,900¹⁶, the entire content of both being incorporated herein by reference. ¹⁵ Chen, Compact fiber optic electronic laser speckle pattern interferometer, U.S. Pat. No. 6,043,870, Mar. 28, 2000.¹⁶ Chen, Compact fiber-optic electronic laser speckle pattern shearography, U.S. Pat. No. 6,040,900, Mar. 21, 2000.

Now making reference to the accompanying drawings, one or more unique, two-dimensional (2D) markers are placed at known locations on the area over which an inspection is to be performed (for example, an aircraft skin for aircraft inspection). Versions of this system accommodate between one and multiple markers to define the inspection space.

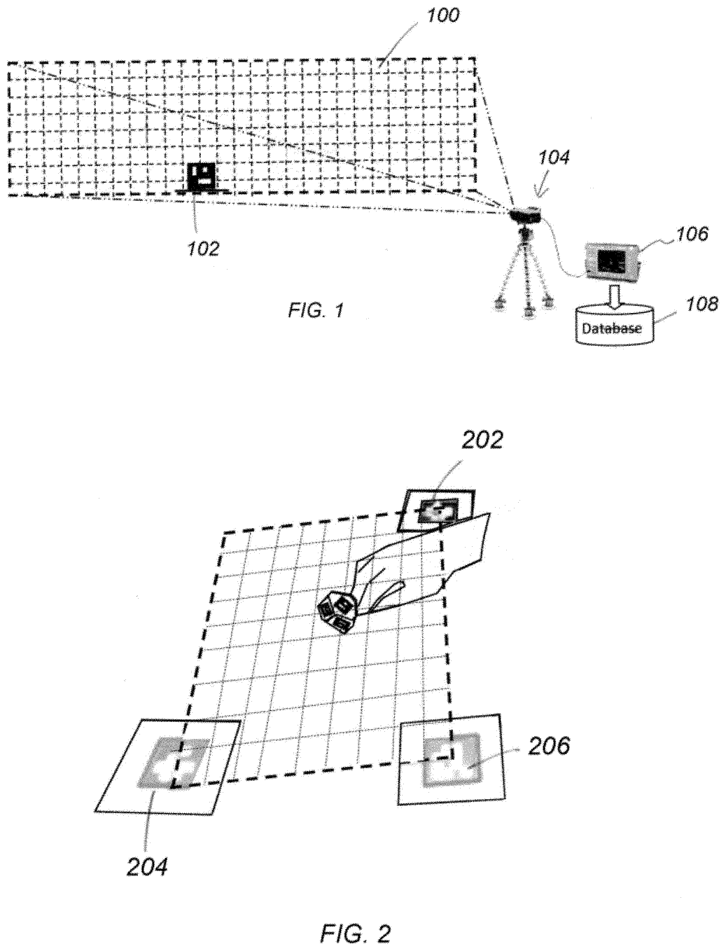

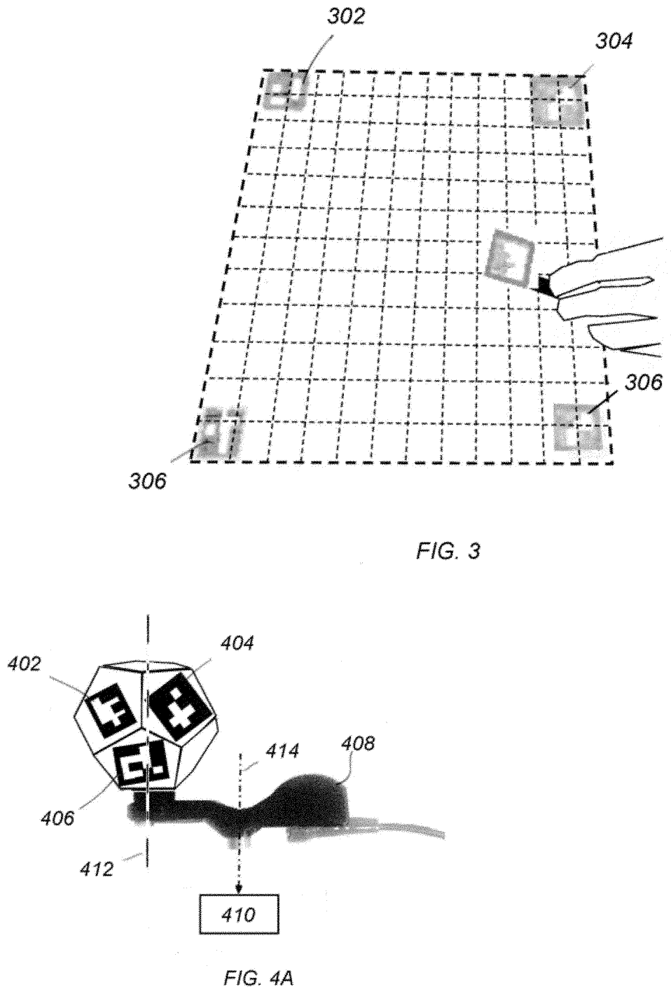

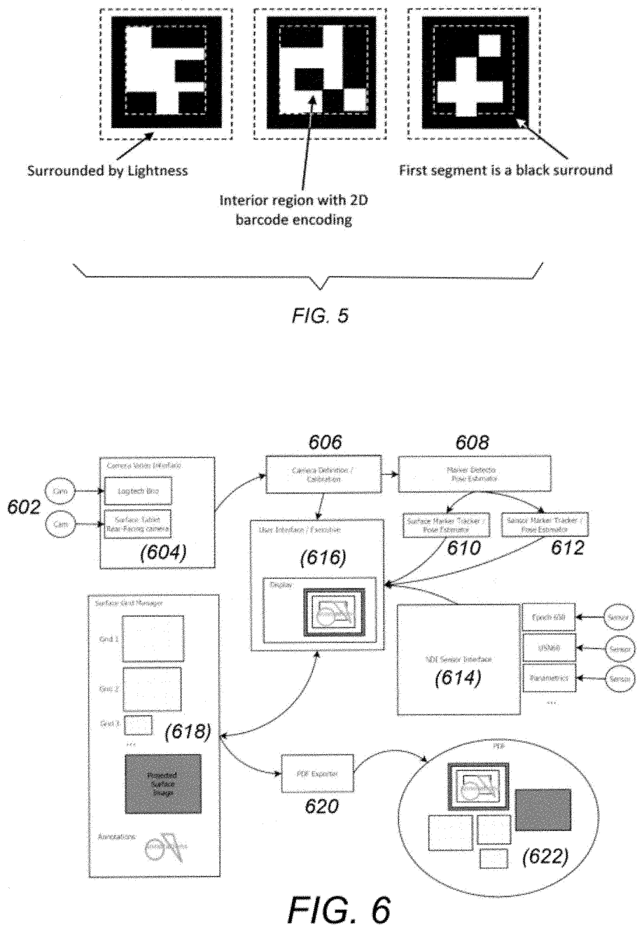

FIG. 1 illustrates the use of a single marker 102 placed on a surface 100. A camera 104 captures an area of surface 100 that includes marker 102. The image(s) are delivered to a database 108 through a computer interface 106 best described with respect to FIG. 6. One marker alone defines a point in space, and any inspections will be located with respect to that point. By employing three markers 202, 204, 206 (FIG. 2) or four markers 302, 304, 306, 308 (FIG. 3), a full six-degree-of-freedom coordinate space can be defined about the area of inspection so inspections are fully located in space and orientation in three-dimensional (3D) space.

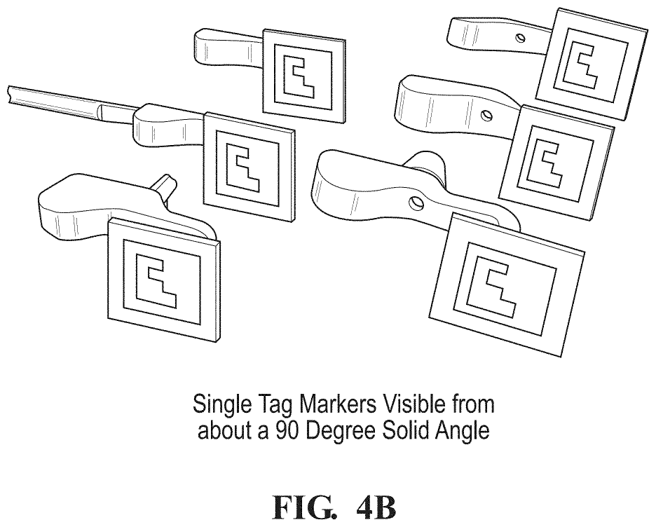

As shown in FIG. 4, to assist with visualization, one or more markers 402, 404, 406 may be mounted on a handle or mounting mechanism 408 that is attached to the inspection sensor(s) or other tracked tool 410. The marker handle or holder 408 mounts the markers on a known geometric form that displays the markers to multiple directions or lines-of sight (FIG. 4a), or from a preferred viewing angle. For example, FIG. 4b shows single-tag markers visible from about a 90-degree viewing angle. In any orientation of the handle mounted marker, one or more of the markers will be visible and identified by their unique marker codes or by their known co-configuration as tracked from a known starting position. Although the marker or markers may be rotatable about axis 412, and the handle 408 rotatable about axis 414, the point of inspection is precisely located at the attachment of handle 408 to sensor 410.

By identifying the markers and their locations, the position of the inspection becomes known. When referencing the known inspection sensor position to the coordinate system defining the inspection space (incorporating the knowledge of where of the handle mounted marker is mounted to the inspection sensor), it is possible to attach to each inspection sensor record the location and orientation of the sensor reading within the inspection space or area.

The markers can be active or passive. For passive markers, augmented reality barcode tag-containing markers (FIG. 5) offer a way to easily make each marketr unique when viewed through a digitized camera image. In the current implementation we have employed open source ArUco¹⁷ markers and open source image processing libraries. These libraries find the marker by filtering the images for black squares within light outer boundaries. Within the black square one can place a unique image for each distinct square, which, as shown in the FIG. 5, is often a black and white barcode that encodes data and the marker identification number. Those of skill in the art will appreciate that other computer-readable codes of differing geometries may be substituted for the markers shown in FIG. 5, including other square, rectangular and circular codes. ¹⁷ ArUco: a minimal library for Augmented Reality applications based on OpenCV, https://www.uco.es/investiga/grupos/ava/node/26; Alternative similar codes have been published by www.scandit.com, QR codes (https://en.wikipedia.org/wiki/QR_code), or ARToolKit (http://www.hitl.washington.edu/arttoolkit/) to name a few.

Software operative to implement the system and method is depicted in FIG. 6. Digital camera(s) 602 gathering images of the inspected area are read into a computer 604, shown as a Brio and Surface, with the understanding that other computer devices having video inputs may be substituted. The video signal is processed in one way to determine camera calibration 606 (i.e., multiple markers on a fixed surface at known locations are used to determine the mapping between camera coordinates and real surface coordinates through regression of the camera transformation to real space mathematics against the known actual locations of the calibration markers). The video signal is processed a second way 608 to determine marker location; in particular, markers are identified in camera field(s), and camera calibration is applied to convert camera coordinates to actual coordinates. Because of shape change of the coded markers, orientation and location can be calculated (see reference to ArUco). Since the codes are unique codes, the specific surface 610 or sensor mounted marker(s) 612 can be identified, defining sensor location 612 and inspection space coordinates 610.

In parallel, the sensor information 614 is read and fused with the sensor location information relative to the area being inspected (perhaps an aircraft fuselage). This allows a user interface 616 to be presented to the operator that displays where inspections are made relative to the inspected object and inspection results referenced to this three-dimensional space. The data may be archived 618 in a longitudinal database for later reference, so that defects detected can be tracked over time. As shown, the data in the database is readily exported in exchange formats (for example, as .PDF 620) for insertion into other applications of analysis, storage, and display 622.

As disclosed in U.S. Pat. No. 6,801,637, the entire content of which is incorporated herein by reference, it is also possible to employ active markers that are identified either by tracking their positions from a known starting configuration (i.e., an emitter is tracked in real time from a starting position so that an expected next location is approximately known and can be used to disambiguate the emitter from any others also visible in the same camera view), or detected through a time modulated code sequence (basically a “Morse code” like code where each active emitter generates a unique code that makes it unique either in sequence or in time of the pulse. The system defined the '637 Patent uses a code that emits a pulse at a time unique to each emitter relative to an elongate pulse from the master emitter. Each uniquely identified active marker is then used in the same way to identify where the inspection sensor is relative to the inspection area as was described previously for passive markers.

Note that passive markers that are not code unique can also be tracked and disambiguated from other markers through tracking their positions from a known starting configuration. Some trackers in the field for body tracking have used non-unique white balls for this type of application.

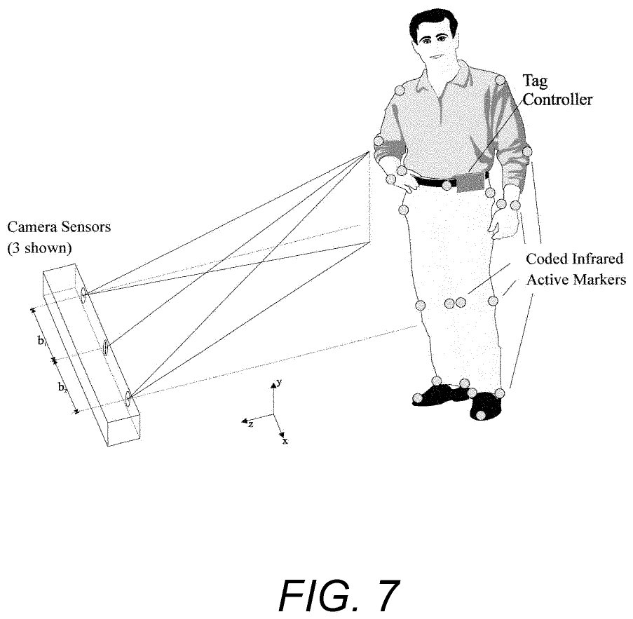

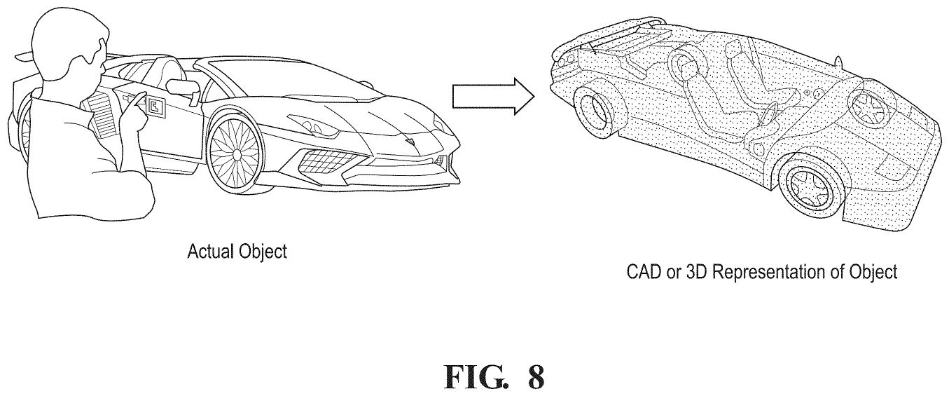

While the invention is ideally suited to the identification of inspection locations relative to an object to be routinely and repeatedly inspectioned, the technology can also be used to track any type of motion in a coordinate space (for instance in FIG. 7, body motion), and used to capture points on the surface of an object in a coordinate space (i.e., a 3D digitization of object surface as a set of 3D points in a 3D point cloud, as shown in FIG. 8.

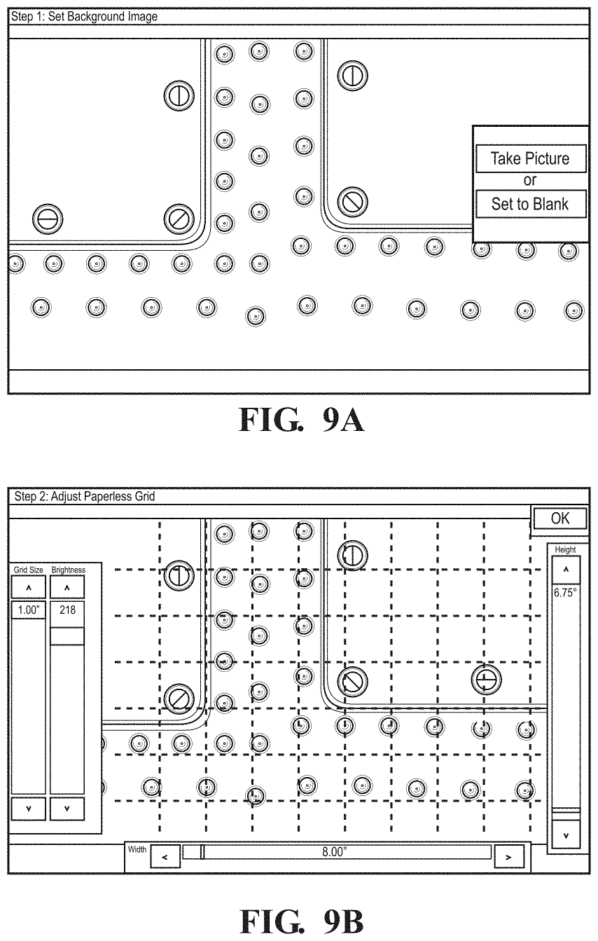

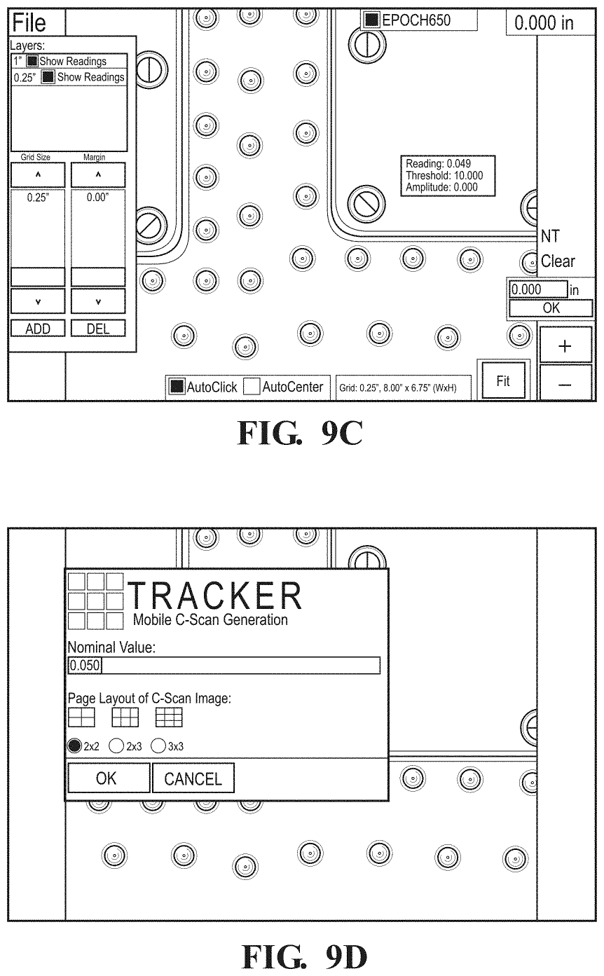

The embodiment of the invention shown in FIG. 9 allows the operator to define an inspection grid over the object to be inspected and then localizes the inspection sensor to a point within that grid, eliminating the need for markers to define the inspection space. FIG. 9A is an image of an inspection area. FIG. 9B illustrates the implementation of a manual grid overlay. FIG. 9C shows the recording of readings on the grid, and FIG. 9D shows the inspection results being exported.

Use of additional markers enables a leapfrogging approach to extend inspection coverage beyond the initial inspection area. As long as one or more existing markers appears in the new inspection area defined by the additional markers, the system will patch the scans together as a contiguous inspection map.

1. A method of inspecting a surface, comprising the steps of:
placing a marker providing a unique computer-readable code on a surface;
providing a camera, and using the camera to gather an image of the surface containing the marker;
processing the image with a programmed computer to develop a coordinate system defining the surface, with the location of the marker being defined as a point with particular coordinates on the surface; and
tracking or determining characteristics of the surface relative to the location of the marker.

2. The method of claim 1, including the step of placing a plurality of the markers at different locations on the surface, each marker having a different unique computer-readable code; and
wherein coordinate system defines a full six-degree-of-freedom coordinate space.

3. The method of claim 1, wherein the computer-readable code is a barcode or other passive code.

4. The method of claim 1, wherein the computer-readable code is an encoded, light-emitting code or other active code.

5. The method of claim 1, wherein the step of tracking or determining characteristics of the surface relative to the location of the marker includes mapping the surface to create a computer-aided design (CAD) representation.

6. The method of claim 1, including the steps of:
coupling the marker to a sensor operative to collect sensor data at or in the vicinity of the marker; and
wherein the step of tracking or determining characteristics of the surface relative to the location of the marker includes merging the coordinates of the marker and the sensor data.

7. The method of claim 6, wherein:
the sensor data is imaging data; and
wherein the step of tracking or determining characteristics of the surface relative to the location of the marker includes generating a multi-staged or dimensional map of the surface.

8. The method of claim 6, wherein:
the sensor data is non-destructive inspection sensor; and
wherein the step of tracking or determining characteristics of the surface relative to the location of the marker includes the step of monitoring flaws or defects in the surface.

9. The method of claim 8, including the step of monitoring flaws or defects in the surface over time.

10. The method of claim 1, wherein the surface forms part of an aircraft, spacecraft, ship or other large object or area.

11. The method of claim 1, including the step of mounting the marker on a fixture enabling the computer-readable code to be imaged from multiple directions, lines of sight, or preferred viewing angles.

12. The method of claim 1, including the step of patching leapfrogged inspection areas to enable a contiguous inspection map.

13. A system for inspecting a surface, comprising:
a marker supported on the surface providing a unique computer-readable code;
a camera operative to gather an image of the surface containing the marker;
a programmed computer operative to receive the image from the camera and develop a coordinate system defining the surface, with the location of the marker being defined as a point with particular coordinates on the surface; and
a human interface enabling a user to track or determine characteristics of the surface relative to the location of the marker.

14. The system of claim 13, wherein:
a plurality of the markers is placed at different locations on the surface, each marker having a different unique computer-readable code; and
the computer is operative to develop a coordinate system defining a full six-degree-of-freedom coordinate space.

15. The system of claim 13, wherein the computer-readable code is a barcode or other passive code.

16. The system of claim 13, wherein the computer-readable code is an encoded, light-emitting code or other active code.

17. The system of claim 13, wherein the computer is operative to map the surface to create a computer-aided design (CAD) representation.

18. The system of claim 13, wherein:
the marker is coupled to a sensor operative to collect sensor data at or in the vicinity of the marker; and
the computer is operative to merge the coordinates of the marker and the sensor data to track or determine characteristics of the surface relative to the location of the marker,

19. The system of claim 13, wherein:
the sensor data is imaging data; and
the computer is operative to generate a multi-staged or dimensional map of the surface using the imaging data.

20. The system of claim 19, wherein:
the sensor is a non-destructive inspection sensor; and
the computer is operative to monitoring flaws or defects in the surface using the sensor data.

21. The system of claim 13, including the computer is operative to monitor flaws or defects in the surface over time.

22. The system of claim 13, wherein the surface forms part of an aircraft, spacecraft, ship or other large object or area.

23. The system of claim 13, wherein the marker is mounted on a fixture enabling the computer-readable code to be imaged from multiple directions, lines of sight, or preferred viewing angles.

24. The system of claim 13, wherein the programmed computer is further operative to patch together leapfrogged inspection areas and generate a contiguous inspection map.
